(19) United States
(12) Patent Application Publication
(10) Pub. No.: US 2013/0090962 A1
(43) Pub. Date: Apr. 11, 2013

(54) PROVIDING VARIABILITY AND MATERIALIZATION OVER LINKS CONNECTING PRODUCT LINE RESOURCES

(71) Applicants: Dolev Dotan, Oshrat (IL); Ian Green, Edinburgh (GB); Mila Keren, Nesher (IL); Andrei Kirshin, Haifa (IL); Shiri Kremer-Davidson, Yavniel (IL); Julia Rubin, Haifa (IL); Dominic Tulley, Edinburgh (GB); Mark N. Wegman, Ossining, NY (US); Tali Yatzkar-Haham, Misgav (IL)

(72) Inventors: Dolev Dotan, Oshrat (IL); Ian Green, Edinburgh (GB); Mila Keren, Nesher (IL); Andrei Kirshin, Haifa (IL); Shiri Kremer-Davidson, Yavniel (IL); Julia Rubin, Haifa (IL); Dominic Tulley, Edinburgh (GB); Mark N. Wegman, Ossining, NY (US); Tali Yatzkar-Haham, Misgav (IL)

(73) Assignee: International Business Machines Corporation, Armonk, NY (US)

(21) Appl. No.: 13/269,640

(22) Filed: Oct. 10, 2011

(51) Int. Cl. G06Q 10/06

(52) U.S. Cl. 705/7.12

(57) ABSTRACT

A system for providing variability and materialization over links connecting product line resources is disclosed herein. The system may include a user interface configured to issue a request for a product-line resource given in a specified product configuration context, responsive to a user selection, wherein the product configuration contains one or more features of the feature model, wherein the product line resources are stored on one or more databases and are further connected between themselves via links, each associated with a respective variability, based on the feature model and the product line resources connected via the links; and a resources fetcher configured to retrieve the resources requested in view of the specified product configuration by providing the links associated with the variability of the specified product configuration.

### BACKGROUND

1. Technical Field

The present invention relates to software development environment and more particularly, to managing a database of product line resources with feature variability awareness.

2. Discussion of the Related Art

In today's customer-driven environment, most companies target the needs of their prospective customers by creating a product line—a portfolio of closely related products with variations in features and functions—rather than just a single product. However, most of today software development tools are focused on the development of a single product. Thus development and maintenance of a family of related products becomes extremely complicated. There is a need for tools that allow to (1) define a product line resources with variability over its artifacts, (2) define a product by selecting variability configuration for it, (3) carry out materialization being generating specific product representation out of the product line according to a given variability configuration. The existing product line solutions often describe a product line by a set of features, and constraints on these features selections. When developing a product line resources, such as the product line requirements, each requirement that is relevant to a certain feature (or features) is marked with the feature it related to.

While there are known variability solution for specific artifacts in specific tools or in a feature model tool (variability over requirements, over classes, over components), there is no known solution for variability and materialization of resources interconnected by links, allowing (1) putting variability on such links and (2) being able to recursively get resources and their linked resources according to specific variability configuration.

### BRIEF SUMMARY

One aspect of the invention provides a computer implemented method. The method may include generating one or more databases that each includes a plurality of product-line resources that are associated with a specific product line based on a specified feature model and a plurality of links representing relationships between the product-line resources and connecting them. The method may further include associating the links with respective variability over the feature model associated with the specific product-line.

Another aspect of the invention provides a system for generating one or more databases of linked product line resources with feature variability attached to the links. The system may include one or more databases configured to store a plurality of product-line resources, all associated with a specific product line and based on a specified feature model. The system may further include a resource builder configured to build within the databases, a plurality of links representing relationships between the product-line resources and connecting them. The system may further include an on-link variability enhancer configured to attach to the links respective variability over the feature model associated with the specific product-line.

Another aspect of the invention provides a system for providing materialization over links connecting product line. The system may include a user interface configured to issue a request for a product-line resource given in a specified product configuration context, responsive to a user selection, wherein the product configuration contains one or more features of the feature model, wherein the product line resources are stored on a database and are further connected between themselves via links, each associated with a respective variability, based on the feature model and the product line resources connected via the links The system may further include a resources fetcher configured to retrieve the resources requested in view of the specified product configuration by providing the links associated with the variability of the specified product configuration.

Yet another aspect of the invention provides a computer program product. The computer program product may include a computer readable storage medium having computer readable program embodied therewith. The computer readable program may include a computer readable program configured to stored on one or more databases, a plurality of product-line resources, all associated with a specific product line based on a specified feature model. The computer readable program may further include a computer readable program configured to build at the one or more databases, a plurality of links representing relationships between the product-line resources and connecting them. The computer readable program may further include a computer readable program configured to associate the links with respective variability over the feature model associated with the specific product-line.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a high level schematic block diagram illustrating an environment of a system according to some embodiments of the invention; and

FIG. 2 is a high level flowchart illustrating the method according to some embodiments of the invention.

The drawings together with the following detailed description make apparent to those skilled in the art how the invention may be embodied in practice.

### DETAILED DESCRIPTION

Prior to setting forth the detailed description, it may be helpful to set forth definitions of certain terms that will be used hereinafter.

The term “product line” as used herein in this application refers to software engineering methods, tools and techniques for creating a collection of similar software systems from a shared set of software assets using a common means of production. The product line can be described by a set of features, and constraints on these features selections. The features may be modeled by a feature model that defines the features and constraints among the feature selection for any valid product. In this feature model, features can be defined as (1) mandatory—which means that they must be part of any product in the product line, (2) optional—which means that there present in a product is optional, (3) alternative—which means that exactly one feature from a group must be in every product. Other constraints among feature selection can also be defined in the feature model.

The term “product line resource” or “resources” as used herein in this application refers to any artifact required and used during the life cycle of software development such as requirements, code, tests and the like.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

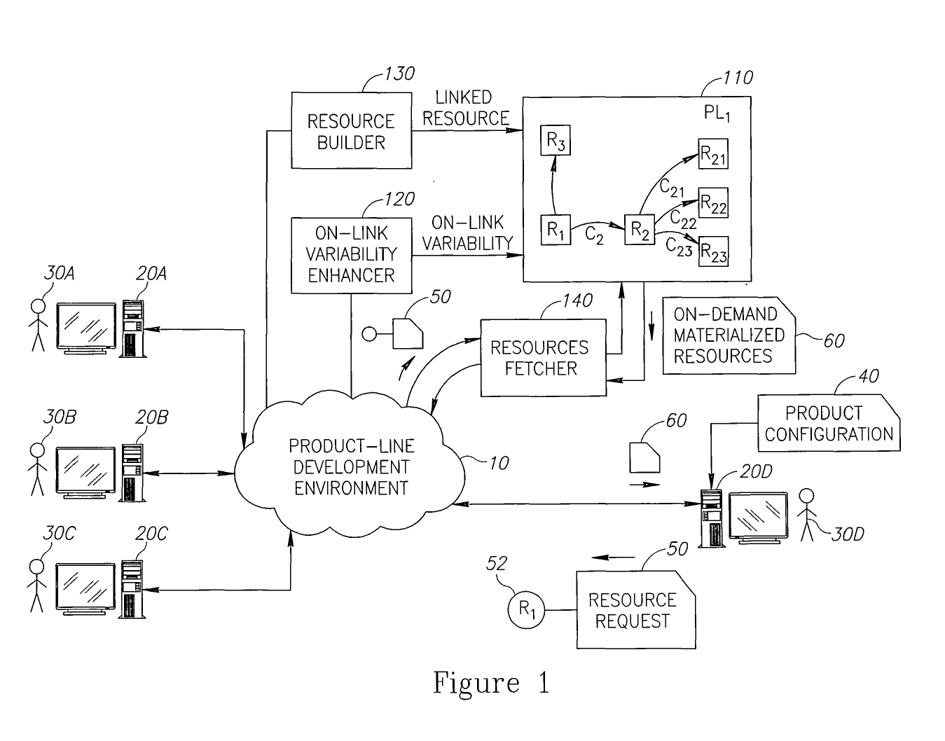

FIG. 1 is a high level schematic block diagram illustrating a non limiting exemplary environment of a system according to some embodiments of the invention. A product-line development environment 10 is shown in a client-server configuration with a plurality of computers 20A-20D on the client side, each associated with a respective user 30A-30D. On the server side, a database 110 of the product line resources is shown. Database 110 is configured to store a plurality of product-line resources, all associated with a specific product line based on a specified feature model (not shown). The feature model determines the architecture of the various products in the product line and the relationships of the various resources within the product line.

The system may further include a resource builder 130 configured to build, within database 110 a plurality of links representing relationships between the product-line resources and connecting them. As shown in database 110, resource R₁ is linked to resource R₃ and to resource R₂ which is linked in turn to resources R₂₁, R₂₂, and R₂₃. The links determine the relationships between the resources and are used to retrieve a specific resource required for retrieval of a resource higher up on the hierarchy. Thus, for example, in order to retrieve resource R₁, resource R₃, R₂, and perhaps R₂₁ might be required.

Additionally, the system may further include an on-link variability enhancer 120 configured to associate the links with respective variability over the feature model of a specific product line. Thus, the links may contain information indicative of specific product configurations that determine the variability of the features for these products. It is noted that the resources themselves lack this information and it is contained instead over the links Traversing over links between resources is therefore made possible in the context of specific product configuration which is a set of variability constrains imposed thereon.

In order to utilize the aforementioned database 110, various resource retrieval mechanisms may be implemented. In a non-limiting exemplary embodiment, the system may further include resources fetcher 140 connected to database 110 on the server side. User 30D may issue, via his or her computer 20D a resource request 50 that may be tagged with a specific resource 52. The request is further issued in the context of a specific product configuration 40 imposing limitations on the feature variability of the resource. Resource request 50 is then transferred from the client side to resources fetcher 140 at the server side. Product configuration 40 may be stored on resources fetcher 140 on the server side in order to eliminate the need for the client (user) to provide it for each resource request.

Resources fetcher 140 then interprets resource request 50 and retrieves the resources requested in view of the specified product configuration 40. Specifically, the resource retrieval involves returning only the links within database 100 outgoing the requested resource which are associated with the variability of the specified product configuration 40.

Described below is a non-limiting exemplary scenario that illustrates embodiments of the present invention in which the resources are linked between themselves in a manned that expresses the variability of their features. It is understood however, that other architectures may be effectively used. User 30D defines a PL₁ resource, R₁ that contains two links: A link to resource R₂ (R1→R2) and a link to resource R₃ (R1→R3). Similarly, links R2→R21, R2→R22, and R2→R23 are defined.

User 30D may define variability over some of the links The variability can be any kind of the known variability patterns such as (1) define a link as optional under some variability condition, or (2) define that several links are alternatives (i.e. only one will be selected). For example, the user at the client defines that the links outgoing from R2 are alternative links, where link R2→R21 should be selected under condition C21, link R2→R22 under condition C22 and link R2→R23 under condition C23, where the conditions are defined over the product line variability (usually concern PL1 features). The user at the client defines the link R1→R2 as optional under the condition C2, meaning that if the condition does not hold, the link to R2 would not be part of the product line resource in that configuration. As shown in FIG. 1, the link R1→R3 is a plain link that shows no variability thereon.

The user at the client defines a product configuration P1, which is a decision over PL1 variability (usually decisions about PL1 features). When the user at the client wishes to get a product line resource in the context of configuration P1, it may apply the normal means of fetching a resource according to its ID, but adds to this request an indication that the context should be the P1 product. This can be done in several ways such as sending P1 as parameter, adding P1 as part of the ID, or using header context. For example, a fetch request to the product line resource R1 under configuration P1 in which the configuration context is given by a parameter, may be written in the following way: R1&conf=P1.

The P1 context is propagated to all further requests for fetching product line resources that are linked to the original product line resource. In the example, the fetched R1 contains the links to R2, R3 with the P1 context, where the link targets are written in the following way: R2&conf=P1 and R3&conf=P1, respectively.

Whenever the server is asked to get a product line resource, e.g. R1, and the ID contains a product context (e.g. R1&conf=P1), the server checks for each of its links whether the link has attached variability. If it doesn't, (e.g. R1→R3) then the server includes the link in the returned resource. If it does, the server evaluates the link's condition according to the context (P1) and includes the link in the returned resource only if the condition evaluated to true. This way the server does not need to perform a full materialization of the product line resources in advance. Only when a product line resource that has variation is needed, the server performs an on-the-fly materialization and returns the selected variant. However, the server may decide to perform the materialization of all the links in advance.

It should be noted that the decision when to fetch linked resources is a mere implementation decision. For example, referring to the example described above, it may be decided that when a product line resource R1 is fetched all its linked product line resources (R2, R3) are fetched as well, or it may be decided to fetch only the product line resource with links to its related product line resources. As another example, assuming that under P1 variability configuration, C21 is evaluated to true, while C22 and C23 are evaluated to false. These values imply that when the server is asked to fetch the related product line resources of R2 under P1 configuration, it fetches R21 since its link is the selected alternative out of the links outgoing from R2.

Consistent with some embodiments of the present invention, the resource retrieval further implements an on-demand materialization of the requested resources, based on the specified product configuration. Specifically, the resources are materialized by applying the feature variability in accordance with the product configuration associated with the resource request. Advantageously, by implementing an ad hoc, generic materialization on the server side, the need to materialize at the client side, thus using decentralized materialization tools at the client side, is eliminated. The generic and ad hoc materialization made possible by resource fetcher 140 saves time and redundancies in materialization tools.

Consistent with some embodiments the retrieving further returns one or more links to product-line resources linked to the requested resources, wherein the one or more links exhibit their variability in the given context of the resource request, in a recursive manner.

Consistent with some embodiments the links are configurable with product-line variability independently of the resources they address.

Consistent with some embodiments wherein the resource builder and the on-link variability enhancer are further configured to update the database by carrying out at least one of: adding, revising, and omitting a specific product-line resource or a link thereto, independently of each other.

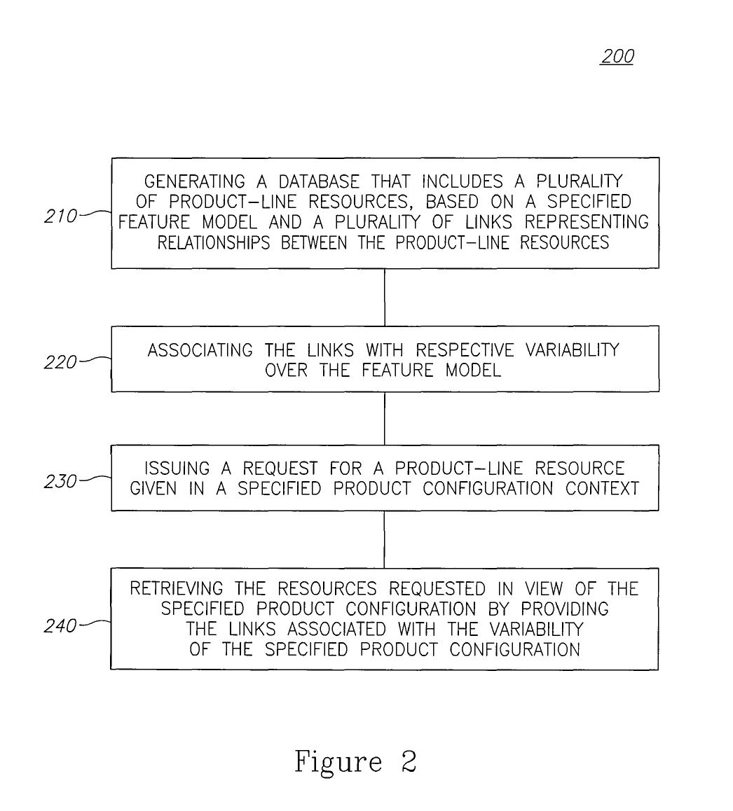

FIG. 2 is a high level flowchart illustrating an exemplary method according to some embodiments of the invention. It is understood that method 200 may be implemented by a different architecture than that of the aforementioned system. However, for the sake of clarity, method 200 is described below in conjunction with components of method 200. Method 200 starts off with generating 210 a database 110 that includes a plurality of product-line resources, all associated with a specific product line based on a specified feature model and a plurality of links representing relationships between the product-line resources and connecting them. The method then goes on to the stage of associating 220 the links with respective variability over the feature model associated with the specific product-line.

Additionally, method 200 may further include steps for retrieval of the resources. This is achieved by the step of issuing 230 a request for a product-line resource given in a specified product configuration context, wherein the product configuration contains one or more features of the feature model. The method goes on to proceed with the stage of retrieving 240 the resources requested in view of the specified product configuration by recursively traversing the links associated with the variability of the specified product configuration.

Alternatively, the method may be carried out differently, without the generating stages as the database may be already prepared for use. In this case, embodiments of the present invention may include the following stages: issuing a request for a product-line resource given in a specified product configuration context, wherein the product configuration contains one or more features of the feature model, wherein the product line resources are stored on a database and are further connected between themselves via links, each associated with a respective variability based on the feature model and the product line resources connected via the links; and retrieving the resources requested in view of the specified product configuration by recursively traversing the links associated with the variability of the specified product configuration.

Consistent with some embodiments of the present invention, the variability is being associated with a link to a resource upon defining that product line resource. When the user asks to get a resource in a specified variability configuration context, such as a specific product configuration, a variability service at the server side, such as resources fetcher 140 fetches the right resource according to the variability configuration context. This process may be iterative, since each fetched resource may have variability over its on-linked resources.

Consistent with some embodiments, when retrieving a resource, the resources fetcher 140 returns the links from that resource—only those links whose condition evaluates to true—including links to primitive values (strings, numbers, etc) which serve as the resource's contents. If the link is to a resource, it returns the link in the context of the product. If the user at the client side so wishes—he or she can retrieve the linked resources themselves.

Consistent with some embodiments, product definitions and configurations may be stored on the server side or alternatively in a manner that is accessible by resources fetcher 140 so that a specified product line such as P1 would have a meaning for the fetcher 140. This way, the need to retrieve the configuration from the client for each one of the resource retrievals is eliminated.

Consistent with some embodiments, the system enables developers to work in a so-called “open” world, where multiple databases in accordance of the present invention work together such that a resource in one of the databases may point to resources in other systems. As long as the variability in the different system uses the same feature model and product definitions, the “on-link materialization” described here should work also when traversing such cross-system links

One advantage of embodiments of the present invention is to enable attaching variability to product line resources in accordance to a paradigm according to which every product line resource has an identifier and is composed using links to other product line resources. This paradigm allows several users working on different products of the product line to seamlessly get different product line resources relevant to their product configuration, although all are asking for the same product line resource. Another advantage of embodiments of the present invention is to enable to fetch a user requested product line resource in generic way by one service on the server side, avoiding implementation of the materialization process in every tool on the client side.

Yet another advantage of embodiments of the present invention is that it allows the use of the same product line resource (e.g. requirement) more than once in the same product line or even in different product lines, placing different variability condition for every product line instance appearance, since the variability is not defined on the product line resource itself but on the links to that product line resource. The variability decision on a product line resource is carried out in the context of the product line resource including it, and is performed in a recursive way since every product line resource can include variability on its links to other product line resources.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

While the invention has been described with respect to a limited number of embodiments, these should not be construed as limitations on the scope of the invention, but rather as exemplifications of some of the preferred embodiments. Other possible variations, modifications, and applications are also within the scope of the invention. Accordingly, the scope of the invention should not be limited by what has thus far been described, but by the appended claims and their legal equivalents.

What is claimed is:

1. A computer implemented method comprising:
generating one or more databases that each includes a plurality of product-line resources that are associated with a specific product line based on a specified feature model and a plurality of links representing relationships between the product-line resources and connecting them; and
associating the links with respective variability over the feature model associated with the specific product-line.

2. The method according to claim 1, further comprising: issuing a request for a product-line resource given in a specified product configuration context, wherein the product configuration contains one or more features of the feature model; and retrieving the resources requested in view of the specified product configuration by returning only the links associated with the variability of the specified product configuration.

3. The method according to claim 2, wherein the retrieving results in an on-demand materialization of the requested resources, based on the specified product configuration.

4. The method according to claim 2, wherein the retrieving returns one or more links to product-line resources linked to the requested resources, wherein the one or more links exhibit their variability in the given context of the resource request, in an iterative manner

5. The method according to claim 1, wherein the links are configurable with product-line variability independently of the resources they address.

6. The method according to claim 1, further comprising updating the one or more databases by carrying out at least one of: adding, revising, and omitting a specific product-line resource or a link thereto, independently of each other.

7. The method according to claim 1, further comprising: issuing a request for a product-line resource given in a specified product configuration context, wherein the product configuration contains one or more features of the feature model, wherein the product line resources are stored on the one or more generated databases ; and retrieving the resources requested in view of the specified product configuration by returning only the links associated with the variability of the specified product configuration.

8. A system comprising:
one or more databases configured each to store a plurality of product-line resources, wherein the resources in the one or more databases are associated with a specific product line based on a specified feature model;
a resource builder configured to build at the at the one or more databases, a plurality of links representing relationships between the product-line resources and connecting them; and
an on-link variability enhancer configured to associate the links with respective variability over the feature model associated with the specific product-line throughout the one or more databases.

9. The system according to claim 8, further comprising a resources fetcher configured to: (i) receive a request for a product-line resource given in a specified product configuration context, wherein the product configuration contains one or more features of the feature model; and (ii) retrieve the resources requested in view of the specified product configuration by returning only the links associated with the variability of the specified product configuration.

10. The system according to claim 9, wherein the retrieving further carries out an on-demand materialization of the requested resources, based on the specified product configuration.

11. The system according to claim 9, wherein the resources retrieval returns one or more links to product-line resources linked to the requested resources, wherein the one or more links exhibit their variability in the given context of the resource request, in an iterative manner

12. The system according to claim 8, wherein the links are configurable with product-line variability independently of the resources they address.

13. The system according to claim 8, wherein the resource builder and the on-link variability enhancer are further configured to update the database by carrying out at least one of: adding, revising, and omitting a specific product-line resource or a link thereto, independently of each other.

14. The system according to claim 8, further comprising: a user interface configured to issue a request for a product-line resource given in a specified product configuration context, responsive to a user selection, wherein the product configuration contains one or more features of the feature model, wherein the product line resources are stored on the one or more databases; and a resources fetcher configured to retrieve the resources requested in view of the specified product configuration by returning only the links associated with the variability of the specified product configuration.

15. A computer program product comprising:
a computer readable storage medium having computer readable program embodied therewith, the computer readable program comprising:
computer readable program configured to stored on one or more databases, a plurality of product-line resources, all associated with a specific product line based on a specified feature model;
computer readable program configured to build at the one or more databases, a plurality of links representing relationships between the product-line resources and connecting them; and
computer readable program configured to associate the links with respective variability over the feature model associated with the specific product-line.

16. The computer program product according to claim 15, further comprising: computer readable program configured to issue a request for a product-line resource given in a specified product configuration context, wherein the product configuration contains one or more features of the feature model; and computer readable program configured to retrieve the resources requested in view of the specified product configuration by providing the links associated with the variability of the specified product configuration.

17. The computer program product according to claim 16, further comprising computer readable program configured to carry out an on-demand materialization of the requested resources, based on the specified product configuration.

18. The computer program product according to claim 16, further comprising computer readable program configured to return one or more links to product-line resources linked to the requested resources, responsive to the resource request, wherein the one or more links exhibit their variability in the given context of the resource request, in an iterative manner

19. The computer program product according to claim 15, wherein the links are configurable with product-line variability independently of the resources they address.

20. The computer program product according to claim 15, further comprising computer readable program configured to update the one or more databases by carrying out at least one of: adding, revising, and omitting a specific product-line resource or a link thereto, independently of each other.
